(19) United States
(12) Patent Application Publication
(10) Pub. No.: US 2021/0365751 A1
(43) Pub. Date: Nov. 25, 2021

(54) Punched Card Capacitive Touch Stamp With Systems And Methods For Authentication

(71) Applicant: SnowShoeFood Inc., Portland, OR (US)

(72) Inventors: Thomas Ree Worley, Sandy Springs, GA (US); Charles Alan McAllister, Portland, OR (US); Jesse Edward Stewart, Portland, OR (US); Alex Norman Haines, Milwaukie, OR (US); Sheradyn Thomas Mikul, Wausau, WI (US)

(73) Assignee: SnowShoeFood Inc., Portland, OR (US)

(21) Appl. No.: 17/321,436

(22) Filed: May 15, 2021

Related U.S. Application Data
(60) Provisional application No. 63/027,145, filed on May 19, 2020.

(51) Int. Cl. G06K 13/02; G06F 3/044; G06F 3/14

(52) U.S. Cl. CPC G06K 13/02; G06F 3/14; G06F 3/044

(57) ABSTRACT

A punched card capacitive touch stamp is disclosed along with systems and methods for authentication using the punched card capacitive touch stamp. The punched card capacitive touch stamp provides for authentication and validation through interaction with a capacitive touch sensor of a computing device such as a smart phone. The punched card capacitive touch stamp has a substrate such as a card, and a plurality of punched holes through this substrate with either clearance for a user's fingers to directly contact the capacitive touch sensor or containing electrically conductive inserts allowing users to indirectly make electrical contact with the capacitive touch sensor. Contact with the capacitive touch sensor in a unique spatial pattern is transferred simultaneously, or in a sequential combination, and is captured by the electronic device and transmitted to an external server to be decoded and authenticated.

### CROSS REFERENCE TO RELATED PATENT APPLICATIONS

This application claims priority to U.S. Patent Application Ser. No. 63/027,145 filed May 19, 2020 entitled “Punched Card Capacitive Touch Stamp With Systems And Methods For Authentication”, the entire disclosure of which is incorporated herein by reference in its entirety.

### FIELD OF THE INVENTION

The present invention relates generally to authentication and validation, and more particularly to a Punched Card Capacitive Touch Stamp With Systems And Methods For Authentication.

### BACKGROUND OF THE INVENTION

Validation and authentication for a variety of purposes is commonly done by way of stamps, punch cards, loyalty cards, magnetic stripe cards, RFID cards, and the like. Validation and authentication may be done for entry to an event, such as an entertainment event, for payment purposes, for identification and security, and the like. The most basic form of validation and authentication is printed paper, such as a paper ticket, paper punch card, etc. As technology has advanced and the need for anti-counterfeiting has grown, advancements such as magnetically encoded strips, radiofrequency identification elements, bar codes, QR codes, and other such elements have become commonplace, as these elements are oftentimes embedded or otherwise integrated into a card, ticket, or a similar validation or authentication device.

As electronic devices such as smart phones and similar devices continue to proliferate, there has been a trend toward simplifying the number of cards, tickets, paper and plastic items that one carries for authentication, validation, and related purposes. While often such authentication and validation can be done entirely on the electronic device, there still remains a need for outside authentication and validation by way of an additional card, ticket, stamp, or the like. Such authentication and validation can be done either by the holder of the electronic device or by another individual or entity as the authenticator or validator.

Electronic devices are commonly constructed with touch screens such as capacitive touch screens. The ability to integrate an authentication or validation item with such electronic devices along with underlying software applications on the electronic device, or through an electronic device to a network or network-based computing element, opens up immense possibilities for authentication, validation, security, payment processing, and transactional business endeavors. There is thus a need for authentication and validation items that integrate with common electronic devices such as smart phones, tablets, and the like. The present invention and the various embodiments described and envisioned herein address this heretofore unmet need.

### SUMMARY OF THE INVENTION

In accordance with the present invention, there is provided a Punched Card Capacitive Touch Stamp that comprises a card, or similar substrate, the substrate having a plurality of holes or openings arranged in a specific geometric pattern, this arrangement of holes or openings allows a user to contact, with their fingers, the touch screen of a computing device, such as a smart phone, through the substrate in a specific coordinate pattern, and in a sequential combination order. This specific coordinate pattern and sequential combination order may be described through graphics printed on the card, or may, in some embodiments, be described in a separate communication such as a text message, an email, a document, a website, or the like.

The foregoing paragraph has been provided by way of introduction, and is not intended to limit the scope of the invention as described herein.

### BRIEF DESCRIPTION OF THE DRAWINGS

The invention will be described by reference to the following drawings, in which like numerals refer to like elements, and in which:

FIG. 1 depicts a plan view of a Punched Card Capacitive Touch Stamp in the embodiment of a drink coaster;

FIG. 2 depicts a plan view of an alternate embodiment of a Punched Card Capacitive

Touch Stamp in the form factor of a postcard;

FIG. 3 depicts a plan view of a Punched Card Capacitive Touch Stamp in the embodiment of a drink coaster with a backing label and conductive inserts;

FIG. 4 illustrates the use of both a touch coordinate pattern and specific contact order for stamp authentication; and

FIG. 5 illustrates the use of a Punched Card Capacitive Touch Stamp with a number of shaped holes and a subset of shapes required for stamp authentication.

The present invention will be described in connection with a preferred embodiment; however, it will be understood that there is no intent to limit the invention to the embodiment described. On the contrary, the intent is to cover all alternatives, modifications, and equivalents as may be included within the spirit and scope of the invention as defined by this specification, claims and drawings attached hereto.

### DESCRIPTION OF THE PREFERRED EMBODIMENTS

A device that uniquely interacts with a touch screen of an electronic computing device such as a “smart phone” is disclosed. The device may be in the form of a card that can be carried in a wallet or purse, incorporated into product packaging, such as a cereal box, included in mailed advertisements or incorporated into a drink coaster. The device in all forms contains a pattern of punched or cut holes, openings or apertures in a substrate such as a paper or plastic card. The holes in this substrate create a unique pattern that is recognized by the electronic device when a user contacts the device touch screen at the location of these holes either simultaneously, semi-simultaneously, or in a sequential pattern, or combination thereof. Alternatively, these holes may be concealed by a thin label, so that a user does not directly contact the device touch screen, but is still able to interact with the touch screen through the thin label, covering, or the like. The label may in some embodiments contain graphics or instructions describing the use of the punched card capacitive touch stamp. It is also possible for these holes to be filled with an electrically conductive insert that allows a user to make contact indirectly through the insert to the device touch screen. Recognition of the unique pattern or pattern sequence in turn activates software in the electronic device. The software may include security software, activation of an app, a video, a store discount, sports statistics, giveaways at events or concerts, entrance to a game, concert or event, entrance and ticketing for transportation such as subways, buses, trains, subscription and gift services, digital loyalty cards, hospitality, toys, games, education, and the like.

U.S. Pat. No. 9,152,279 to Moberg et al. and entitled “Tool And Method For Authenticating Transactions”, U.S. Pat. No. 9,298,907 to Moberg et al. and entitled “Methods For Enabling Real-Time Digital Object And Tangible Object Interactions”, U.S. Pat. No. 9,832,644 to Moberg et al. and entitled “Systems And Methods For Hybrid Hardware Authentication”, U.S. Pat. No. 9,876,795 to Moberg et al. and entitled “Methods For Enabling Real-Time Digital Object And Tangible Object Interactions”, and U.S. Pat. No. 10,599,831 to Moberg et al. and entitled “Increased Security Method For Hardware-Tool-Based Authentication” are incorporated by reference herein in their entirety, as permissible by national or regional laws.

The Punched Card Capacitive Touch Stamp of the present invention comprises a substrate, the substrate having a plurality of holes or openings arranged in a specific geometric pattern, this arrangement of holes or openings is configured to allow a user to contact, with their fingers, the touch screen of a computing device, such as a smart phone, through the substrate in a specific coordinate pattern, and in a sequential combination order. This specific coordinate pattern and sequential combination order may be described through graphics printed on the substrate, or may, in some embodiments, be described in a separate communication such as a text message, an email, a document, a website, or the like. In some embodiments, the holes or openings contain an electrically conductive insert. In some embodiments of the present invention, an outer layer covers the holes or openings at least on one side, and may contain branding, advertising, messages, graphics, or the like. The holes may be circular or non-circular, and may further contain complex or additional geometries.

A system of the present invention includes at least one embodiment of the Punched Card Capacitive Touch Stamp as well at least one method for authentication on an electronic device, as further described herein.

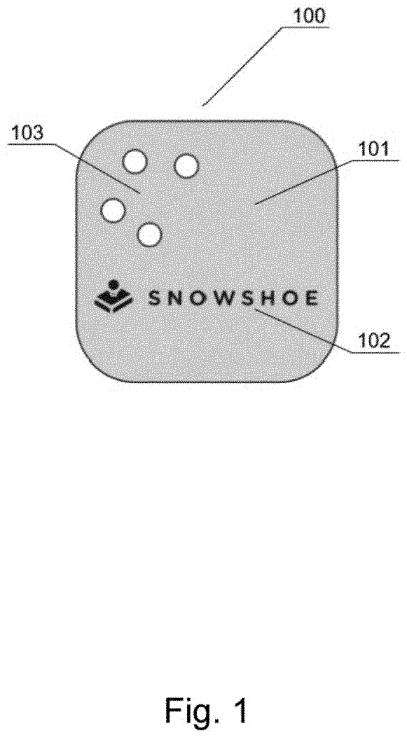

Turning now to the drawings, FIG. 1 depicts an example of a Punched Card Capacitive Touch Stamp 100 in accordance with the present invention in the form factor of a cardboard drink coaster with company branding 102. The substrate in this example may be rectangular, square or circular. Of course, in other embodiments there may be different shapes employed. A substrate 101 may be made from cardboard or paper, a plastic, vellum, or the like, and may, in some embodiments, be incorporated within existing product packaging. Punched or cut holes arranged in a specific and unique layout create a unique hole pattern of points having a unique set of coordinates, such as a four-point pattern 103. In addition, in some embodiments of the present invention, these holes may be of a variety of geometries, for example, octagon, square, triangle, rectangle, hexagon, or the like. In some embodiments of the present invention, there may be more than four or less than four holes, openings, or apertures. To use the Punched Card Capacitive Touch Stamp, the stamp pattern is placed in contact with a touch screen of an electronic device. Contact by the user's fingers through the unique pattern of punched holes is detected by the touch screen, which in-turn, activates or otherwise enables a software application.

The punched card capacitive touch stamp of the present invention comprises a substrate; a plurality of holes in the substrate wherein the plurality of holes are arranged in a unique layout that can be correlated to a set of coordinates; an electrically conductive insert placed in at least one of the plurality of holes; and a user contact area that allows a user to provide capacitance to the electrically conductive insert. The user contact area may, in some embodiments, be the conductive insert itself, or may, in other embodiments, be an electrically conductive pad or area that is electrically connected to at least one conductive insert.

The conductive inserts may be made from a conductive material such as, but not limited to, a conductive ink that is printed on the substrate in a unique pattern that is recognized by the electronic device when the pattern contacts the touch screen of the device. Other conductive inserts may include metals such as copper, aluminum, steel, brass, and the like. Recognition of the unique conductive trace pattern of the conductive inserts in turn activates software in the electronic device. The software may include security software, activation of an app, a video, a store discount, sports statistics, giveaways at events or concerts, entrance to a game, concert or event, entrance and ticketing for transportation such as subways, buses, trains, subscription and gift services, digital loyalty cards, hospitality, toys, games, education, and the like.

In some embodiments of the present invention, a user contact area or structure may be employed in the form of a conductive pad or similar structure.

While the figures herein depict the conductive pattern exposed, in some embodiments the conductive pattern may be embedded within another layer of material such as cardboard, paper, a plastic, vellum, or the like to both protect the conductive pattern and hide it from view.

In some embodiments of the present invention, there may be more than four circles, points, or other geometries, or less than four circles, points or other geometries formed from the conductive inserts. In addition, in some embodiments of the present invention, the points may be of a variety of geometries, for example, octagon, square, triangle, rectangle, hexagon, or the like. The conductive circles or points arc each made from a conductive material and may have a conductive trace that leads back to a user contact area (a conductive area) that the user is in contact with. The contact or conductive area is of sufficient size to allow a user to easily land on the conductive area with a finger or thumb. In one embodiment, the user must be in contact with this area to provide capacitance to the circles or points in order for the device to work. The user contact area may be located along a side of the substrate. The user contact area may be rectangular or of a conforming geometric shape.

In some embodiments of the present invention, the conductive points or circles are interconnected by way of conductive traces.

In some embodiments of the present invention, a layer covers the conductive points and the substrate, and may be made from a paper, a plastic, a coating, or the like. The layer serves not only to protect the conductive points and the substrate, but also serves to obscure the conductive point pattern (“the signet”) from view. This layer may also contain graphics, lettering, or the like. The substrate and, in some embodiments of the present invention, the layer covering, may be rectangular to conform to the geometric appearance of a business card, a credit card, or the like. Other shapes may also be employed, for example, round, square, hexagonal, octagonal, and the like.

The conductive points (geometries) are placed in different locations to produce unique devices. There are estimated to be more than 3 million unique patterns that can be created with the basic technology described. Different geometries and configurations as well as changes to touch screen detection and processing will yield significantly more unique patterns. For example, software-based techniques may yield a greater number of unique patterns.

To use the Punched Card Capacitive Touch Stamp, the device is placed in proximity to or in contact with a touch screen of an electronic device. The unique pattern of the capacitive points, when held by a user, are detected by the touch screen and in turn activate or otherwise enable a software application. Activation of software applications by the device of the present invention is also considered an integral part of the present invention and the various embodiments described and envisioned herein.

The electrically conductive inserts may be in the form of an embedded material with conductive properties or a conductive material deposited or printed onto the substrate. The substrate can be constructed of any material that will function as a dielectric layer, insulating the conductive regions of the device and preventing interference by the user touching the conductive insert or pad. The conductive inserts can be made of any material capable of transferring an electron charge from the user to the conductive regions, such as a metal foil, insert. or a conductive coating.

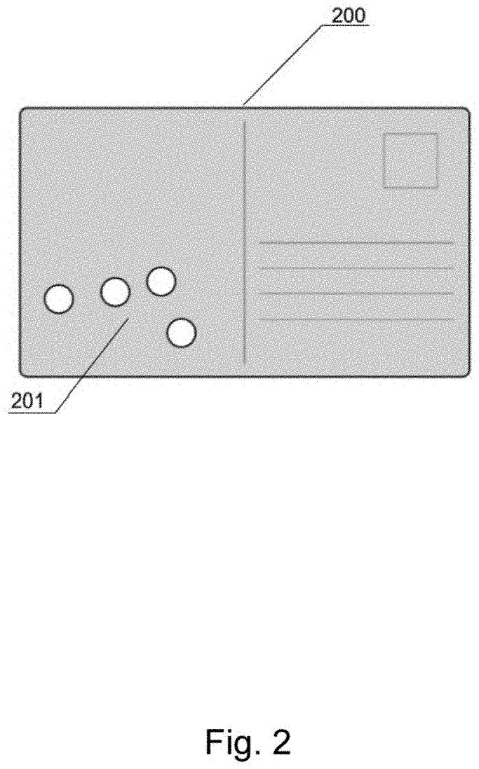

FIG. 2 depicts an alternate embodiment of the Punched Card Capacitive Touch Stamp 200 in the form of a typical postcard with a four-point pattern created by the punched holes 201. In some embodiments of the present invention, there may be more than four or less than four holes, openings, or apertures. In this embodiment, the Punched Card Capacitive Touch Stamp can be mailed to users as part of a promotional event or loyalty program.

In further embodiments of the present invention, the hole pattern is covered on one side of the substrate while retaining the hole pattern on the opposite side; for example, a thin label with product branding could cover the substrate hole pattern on one side of the substrate, which would still allow a user to place their fingers in close proximity to the touch screen and thereby still trigger a touch event with the electronic device.

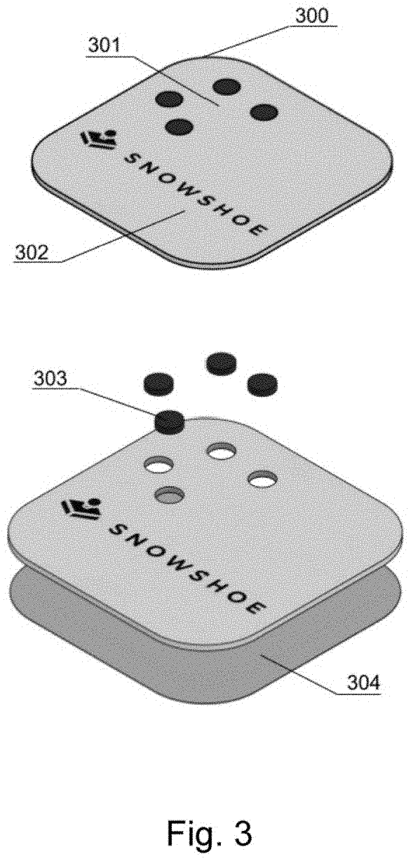

FIG. 3 shows an alternate embodiment of a drink coaster 300 with a unique hole pattern 301 that is concealed on one side by a thin label 304 to allow for product branding. In this embodiment conductive inserts 301 are also placed into the holes to create a uniform surface on both sides of the coaster. These conductive inserts would allow for indirect contact with a device touchscreen by transferring a user's electrical charge through the insert when they place their fingers on the contact points.

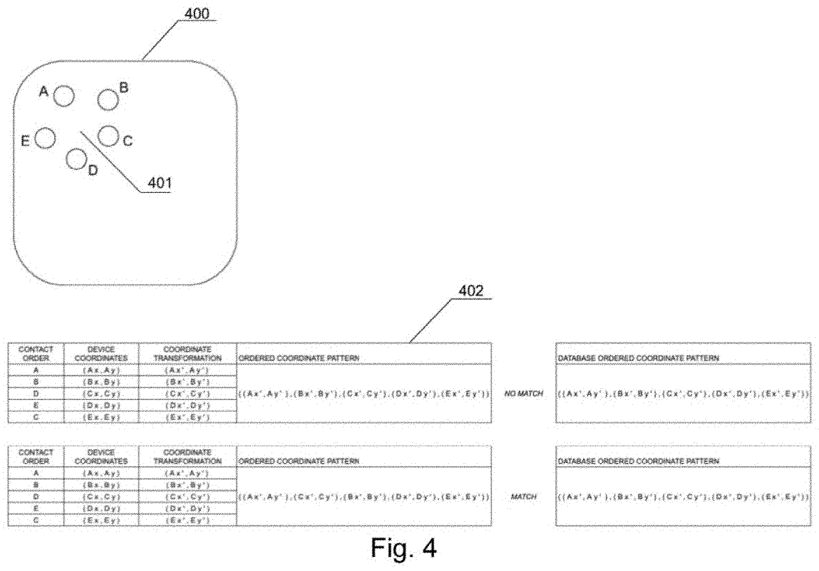

The number of unique patterns available is determined by the number of holes, the pattern area, and the sequence of touch location entry. Future touch screen technology improvements may also allow for additional unique combinations, such as the incorporation of touch shape, touch pressure, and transient event sensitivity. In FIG. 4, a five hole pattern is contained in a card 400. The coordinates locations of the hole pattern 401 are compared against a reference database 402 as part of an authentication process. The hole coordinates in this example are transformed from the device touchscreen coordinate system to a reference coordinate system and compared, in their contact order against a database. Authentication in this example requires that both the pattern coordinates and the contact order match an ordered coordinate pattern database. It should be noted that this method may also include simultaneous or semi-simultaneous touch entries, as well as sequential touch entries. These additional touch entry modes appear as further database coordinate entries with a delimiter such as “sequential” or “simultaneous” being assigned to the coordinate entries in the database.

The present invention includes methods for authentication on an electronic device having a capacitive touch sensor, a method of the present invention comprising detecting, on the capacitive touch sensor, a first set of points of capacitively interactive contact resulting from a user's finger contact through a Punched Card Capacitive Stamp to the capacitive touch scnsor; wherein the first sct of points is arranged in a unique spatial pattern and the unique spatial pattern is detected by the capacitive touch sensor; computing, from the first set of points, a first set of parametric descriptors; generating a first comparison between the first set of parametric descriptors and a set of known parametric descriptors; and authenticating an event on the electronic device based on the first comparison.

The method may also include detecting, on the capacitive touch sensor, a second set of points defined by the patterned template, wherein the second set of points is detected an elapsed time after the first set of points is detected; computing, from the second set of points, a second set of parametric descriptors; and generating a second comparison between the second set of parametric descriptors and the set of known parametric descriptors; wherein authenticating an event on the electronic device further comprises authenticating an event on the electronic device based on the first comparison and the second comparison.

The method may also include detecting a motion of the patterned template relative to the electronic device; wherein authenticating an event on the electronic device further comprises authenticating an event on the electronic device based on the motion.

The method may also include determining an orientation of the patterned template from the first set of points; wherein computing the first set of parametric descriptors further comprises computing, from the first set of points and the orientation, the first set of parametric descriptors.

The method may further include sending data characterizing the first comparison to an external authentication server and receiving an authentication response from the external authentication server.

A further method of the present invention includes a method for authentication on an electronic device having a capacitive touch scnsor and a display, the method comprising: detecting, on the capacitive touch sensor, the punched card capacitive touch stamp of the present invention; generating, on a computer having a processor, memory and access to computer readable media, a parametric descriptor from the unique pattern of holes of the punched card capacitive touch stamp of claim 1; and converting, on the computer, the parametric descriptor to a user message that is displayed on the display of the electronic device.

The method may further comprise the step of providing on the display of the electronic device a message containing user instructions or user content. Such messages or content may include text, graphics, images, videos, or the like. The message or messages may also contain a web site link to guide the user to take further action or view additional information.

The method may further comprise the step of detecting, on the capacitive touch sensor, movement of the punched card capacitive touch stamp in relation to the capacitive touch sensor. This step may be for error detection and correction, or in some embodiments of the present invention, the punched card capacitive touch stamp may have functionality enabled by a swipe or similar movement of the punched card capacitive touch stamp.

The method may further comprise the step of detecting, on the capacitive touch sensor, a change in capacitance of the electrically conductive insert. The change of capacitance may be the result of the placement of a user's finger on the conductive insert or an electrically connected pad or area.

The method may further comprise the step of detecting, on the capacitive touch sensor, finger placement on the capacitive touch sensor. Finger placement may cause a change in capacitance that can be detected on the capacitive touch sensor.

The method may further comprise the step of providing a parametric descriptor to a network by way of a computer or computers.

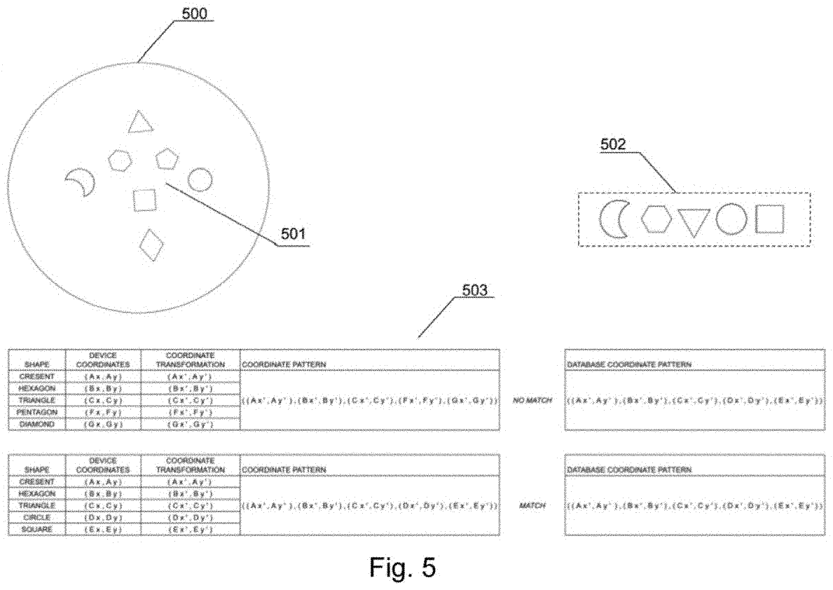

FIG. 5 depicts a circular embodiment 500 of the Punched Card Capacitive Touch Stamp that contains a pattern of seven shaped holes at known coordinates 501. In this embodiment, a specific subset of shapes 502 is communicated to the stamp user through a website or through an application, and authentication would require touch coordinates to match the known coordinates for this subset of shapes 503.

While the various objects of this invention have been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of this specification and drawings appended herein.

What is claimed is:

1. A punched card capacitive touch stamp comprising:
a substrate having a top side and a bottom side;
a plurality of holes in the substrate wherein the plurality of holes are arranged in a unique pattern that can be correlated to a set of coordinates;
an electrically conductive insert placed in at least one of the plurality of holes and configured to interact with a capacitive touch screen of an electronic device; and
a user contact area that allows a user to provide capacitance to the electrically conductive insert.

2. The punched card capacitive touch stamp of claim 1, wherein the user contact area comprises at least one electrically conductive insert.

3. The punched card capacitive touch stamp of claim 1, wherein the user contact area comprises a pad area that is electrically connected to at least one electrically conductive insert.

4. The punched card capacitive touch stamp of claim 1, further comprising a label covering the top side of the substrate.

5. The punched card capacitive touch stamp of claim 4, wherein the label further comprises graphics describing use of the punched card capacitive touch stamp.

6. The punched card capacitive touch stamp of claim 1, further comprising a label covering the bottom side of the substrate.

7. The punched card capacitive touch stamp of claim 1, wherein the holes are circular.

8. The punched card capacitive touch stamp of claim 1, wherein the holes are non-circular.

9. The punched card capacitive touch stamp of claim 1, wherein the substrate is rectangular.

10. The punched card capacitive touch stamp of claim 1, wherein the substrate is circular.

11. The punched card capacitive touch stamp of claim 1, wherein the substrate comprises a postcard.

12. The punched card capacitive touch stamp of claim 1, wherein the plurality of holes comprises four holes arranged in a unique pattern.

13. The punched card capacitive touch stamp of claim 1, wherein the plurality of holes comprises five holes arranged in a unique pattern.

14. A method for authentication on an electronic device having a capacitive touch sensor and a display, the method comprising:
detecting, on the capacitive touch sensor, the punched card capacitive touch stamp of claim 1;
generating, on a computer having a processor, memory and access to computer readable media, a parametric descriptor from the unique pattern of holes of the punched card capacitive touch stamp of claim 1; and
converting, on the computer, the parametric descriptor to a user message that is displayed on the display of the electronic device.

15. The method of claim 14, further comprising the step of providing on the display of the electronic device a message containing user instructions.

16. The method of claim 14, further comprising the step of detecting, on the capacitive touch sensor, movement of the punched card capacitive touch stamp in relation to the capacitive touch sensor.

17. The method of claim 14, further comprising the step of detecting, on the capacitive touch sensor, a change in capacitance of the electrically conductive insert.

18. The method of claim 14, further comprising the step of detecting, on the capacitive touch sensor, finger placement on the capacitive touch sensor.

19. The method of claim 14, further comprising the step of providing, on the computer, the parametric descriptor to a network.

20. The method of claim 14, wherein the user message contains a web site link.
